(19) United States
(12) Patent Application Publication
(10) Pub. No.: US 2010/0041008 A1
(43) Pub. Date: Feb. 18, 2010

(54) INTEGRATED LEARNING MANAGEMENT SYSTEM AND METHODS

(75) Inventors: Francisco R. Perez, Lake Forest, CA (US); Timothy A. Kleczka, Villanova, PA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: NEW HORIZONS EDUCATION CORPORATION, Anaheim, CA (US)

(21) Appl. No.: 12/582,505

(22) Filed: Oct. 20, 2009

(51) Int. Cl. G09B 7/00

(52) U.S. Cl. 434/350; 434/362

(57) ABSTRACT

Integrated learning management is provided for a computer assisted learning system having an instructor led training component (ILT) and a computer based training (CBT) component. The CBT component has a plurality of training materials and a content management service (CMS) that (i) controls an interface between the ILT component and the CBT component. An integrated learning management system and method enforces a plurality of standards upon the ILT component and the CBT component, each said standard governing at least one of quality, uniformity and branding.

### FIELD OF THE INVENTION

The field of the invention relates in general to computer assisted teaching methods, and, in particular, to a learning management system and method that integrates and manages provision of training services having an instructor led component and a computer based training component.

### BACKGROUND OF THE INVENTION

The assignee of the present invention operates and franchises learning centers which provide computer assisted instruction and training for individuals. Such training may be tailored, for example, to individuals needing general business skills, computer application skills, technical certifications and/or vendor specific skills to obtain or enhance employment opportunities in the information technology (IT) industry.

Advantageously, training is provided in a hybrid environment that incorporates computer implemented video-based instruction, web-interactive techniques, and a human mentor (instructor) in the education process. The hybrid environment may feature one-on-one instruction, hands-on lab exercises, multi-sensory tools, individual learning paths and flexible scheduling. The assignee of the present invention has developed training methods and curricula using such hybrid training environments under the trade name New Horizons MENTORED LEARNING™.

Preferably, training services such as New Horizons MENTORED LEARNING™ should be delivered in a uniform manner across every learning center and comply with standards governing, for example, quality and branding. Using previously known techniques, this has proven difficult to accomplish in the face of a broad geographic diversity of learning centers and a wide range of curriculum subject matter.

### SUMMARY

The present inventors have recognized and solved this problem with a method and system wherein a content management service (CMS) controls an interface between an instructor led training (ILT) component and a computer based training (CBT) component, and the system enforces a plurality of standards upon the ILT component and the CBT component, where each standard governs at least one of quality, uniformity and branding.

In an embodiment, at least one of the CBT and ILT are remote from the CMS.

In a further embodiment, the CMS manages data related to training activities of at least one student. Moreover, the CMS may communicate the data to at least one of the LMS and the ILT component.

In another embodiment, a single CMS is configured to be operable with a plurality of CBT and ILT components.

In an embodiment, the CMS manages a resource, including a classroom, an instructor, and/or a courseware manual inventory.

In further embodiments, the CMS displays to an instructor a work station assigned to a student, tracks progress of a student and/or CMS tracks available student credits.

In another embodiment, the CMS consists of at least one computer platform communicatively coupled, over a network, to at least one work station located at a learning center that includes the ILT.

### BRIEF DESCRIPTION OF THE DRAWINGS

Illustrative embodiments of the principles of the present invention are described in detail below with reference to the attached drawing figures, which are incorporated by reference herein and wherein:

FIG. 1 is a block diagram illustrating principal elements for providing a computer assisted teaching service;

FIG. 2 is a block diagram of a an illustrative system embodiment of an illustrative system embodiment; and

FIG. 3 is a flow chart illustrating steps in an illustrative method embodiment.

### DETAILED DESCRIPTION OF THE DRAWINGS

A detailed description of preferred embodiments of the present invention is provided hereinbelow. It is to be understood, however, that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

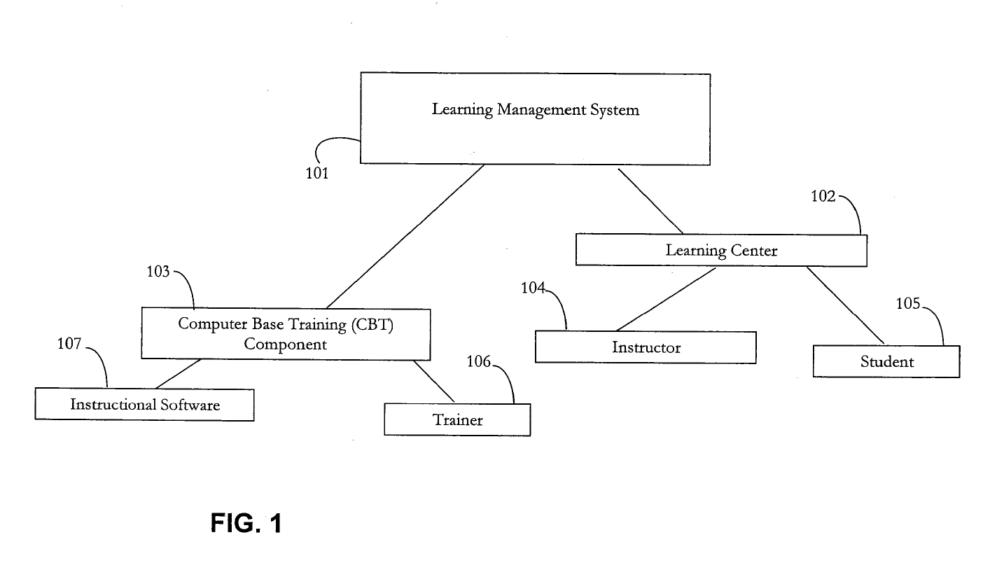

Referring now to FIG. 1, a computer assisted teaching service may be provided under the control and supervision of a learning management system (LMS) 101. LMS 101 may provide for management of a plurality of learning center 102, and for procurement of computer based training (CBT) component 103. Each learning centers 102 may be operated, for example by an affiliate, a subsidiary or a franchisee of the operator of LMS 101. A learning center 102 may be a classroom at a specific geographic location, thereby providing a learning environment where an instructor 104 trains and mentors a student 105. Alternatively, a learning center may be a virtual space where instructor 104 and student 105 may interact over a network, for example a local area network, or the Internet.

Learning center 102 may provide an environment in which a computer based training component 103, may be provided to a student 105 under the guidance and/or control of instructor 104. Advantageously, CBT component 103 may include a variety of training materials, such as, for example, computer implemented video-based instruction, hands-on lab and training exercises, interactive, instructive “games” and the like, that may be accessed at a computerized learner workstation. As discussed hereinbelow, the learner workstation may be (but is not necessarily) located at learning center 102.

CBT component 103 may, for example, be produced by a third party content provider, but are advantageously developed only in strict compliance with specifications developed and enforced by LMS 101. LMS 101, for example, may specify a detailed syllabus and curriculum for a training package, and the number and nature of modules within the training package. For example, LMS 101 may require that a particular module have a certain proportion of content in lecture format, a particular proportion in lab format, a particular proportion for skills assessment, etc. Moreover, LMS 101 may provide specifications with respect to uniformity and branding. Thereby all training materials, even if procured from a variety of third party content providers, may be required to have a similar “look and feel”, and adhere to a policy of LMS 101 with respect, for example, to trademarks, trade dress and copyright.

Advantageously, the content of CBT component 103 may include instructional software 107 accompanied by video recorded lectures by a trainer 106. Generally, trainer 106 and instructor 104 will be different individuals, but this is not necessarily so. CBT component 103 may also include a variety of software modules permitting student 105 to interact with CBT materials in various ways. For example, some software modules may provide a hands-on laboratory environment, others may provide skill assessment tests, while still others provide interactive, instructive “games”. CBT component 103 may advantageously be provided to learning center 102 only under the supervision and control of LMS 101.

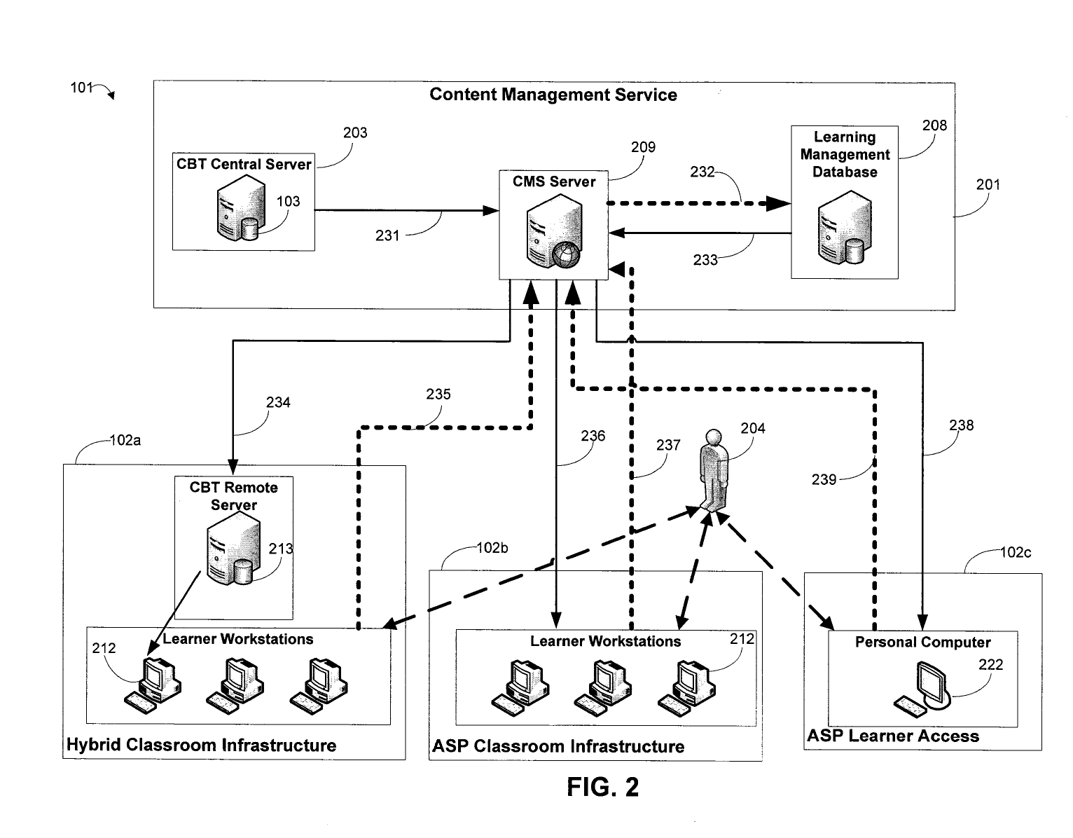

Referring now to FIG. 2, a learning management system 101 will be described, wherein a content management service (CMS) 201 controls an interface between an instructor led training (ILT) component 204 and a computer based training (CBT) component 103 and enforces a plurality of standards upon ILT component 204 and CBT component 103. Each standard may govern at least one of quality, uniformity and branding.

In an embodiment, CMS 201 may be implemented on one or more computer platforms. For example, as illustrated in FIG. 2, CMS 201 may include CBT central server 203, on which CBT component 103 is stored, a learning management database 208 and a CMS server 209. As discussed hereinabove, training materials for CBT component 103 are advantageously developed only in strict compliance with specifications developed and enforced by LMS 101. Once developed, they may be stored in CBT central server 203. Content updates may be pushed from CBT central server 203 to CMS server 209, as illustrated by signal path 231. CMS server 209 may make the content accessible to learning center 102, student 105, and/or instructor 104 under conditions specified by LMS 101 and controlled by CMS 201, as will be described in more detail hereinbelow.

In an embodiment, learning management database 208 may be part of CMS 201. Advantageously, learning management database 208 provides a central storage location for student information profile which may include, for example, student identification, corporate affiliation, financial account information, transcripts, course information and other academic details. CMS server 209 and learning management database 208 may exchange information via signal paths 232 and 233. For example, student information, including a profile, learning credits and transcripts acquired by CMS server 209 from learning center 102 may be sent via signal path 232 to learning management database 208. Similarly, CMS server 209 may retrieve information from learning management database 208 such as class information, schedule and instructor information via signal path 233.

CMS server 209 may provide a hub interface with, on the one hand, CBT central server 203 and learning management database 208, and on the other hand, a plurality of learning centers 102. Advantageously, a large number of learning centers 102, in a diversity of geographic locations remote to CMS 201, may be communicatively coupled to CMS server 209. Preferably, CMS server 209 enables a learning center 102 to access content only under terms and conditions specified by LMS 101. For example, security conditions and policies may be enforced to prevent piracy of or unauthorized access to materials from CBT component 103, and to prevent unauthorized modification of those materials.

As described hereinabove, LMS 201 may enforce standards upon CBT component 103, by ensuring, for example, that CBT component 103 meet specified requirements for uniformity, quality and branding. LMS 201 may enforce compliance with these standards by, for example, making such compliance a prerequisite to storing CBT component 103 on CBS central server 203, or a prerequisite to allowing a learning center 102 to access CBT component 103.

As described hereinafter, learning centers 102 may have different configurations, three of which are illustrated in FIG. 2, and identified as 102a, 102b, and 102c.

In a first configuration, learning center 102a may include a physical learning environment with a plurality of student workstations 212, a CBT remote server 213, and an ILT component 204. In accordance with a policy of LMS 101, CBT remote server 213 may be supplied with all or a subset of CBT component 103. CBT component 103 may be downloaded from CBT central server 203 by way of CMS server 209 via signal path 234. Updates to CBT component 103 may be pushed to CBT remote server 213 in accordance with a policy of LMS 101 signal path 234. A substantial number of learner workstations 212 may be communicatively coupled to CBT remote server 213, and access content therefrom. Advantageously, learner workstations 212 are likewise communicatively coupled to CMS server 209, via, for example signal path 235. Thereby, CMS server 209 may provide a control function to ensure, for example that an operator of a learner workstation 212, who will generally be a student 105, only accesses portions of CBT component 103 that student 105 is authorized to access. Moreover, a policy of LMS 101 may be enforced, for example, to prevent a student 105 from “skipping ahead” in a training package or module, and/or from accessing CBT content for which student 105 has not paid. Additionally, progress of student 105 through a training package and/or module may be monitored by CMS server 209, which may in turn update learning management database 208 accordingly. Advantageously, student 105 has real time access to ILT component 204, which may consist of instructor 104 and various off-line instructional tools and information.

In a second configuration, learning center 102b may include a physical learning environment with a plurality of student workstations 212 and an ILT component 204. In accordance with a policy of LMS 101, a learner workstation 212 may be supplied on request with a subset of CBT component 103. CBT component 103 may be downloaded from CBT central server 203 by way of CMS server 209 via signal path 236. A substantial number of learner workstations 212 may be communicatively coupled to CMS server 209, and access content therefrom. CMS server 209 may provide a control function to ensure, for example that an operator of a learner workstation 212, who will generally be a student 105, only accesses portions of CBT component 103 that student 105 is authorized to access. Thereby, a policy of LMS 101 may be enforced, for example, to prevent a student 105 from “skipping ahead” in a training package or module, and/or from accessing CBT content for which student 105 has not paid. Additionally, progress of student 105 through a training package and/or module may be monitored by CMS server 209, via, for example signal path 237, which may in turn update learning management database 208 accordingly. Advantageously, student 105 has real time access to ILT component 204, which may consist of instructor 104 and various off-line instructional tools and information.

In a third configuration, learning center 102c may include a virtual learning environment wherein a student 105 may use a personal computer 222 to access CBT component 103 and interact with an ILT component 204. In accordance with a policy of LMS 101, personal computer 222 may be supplied on request with a subset of CBT component 103. CBT component 103 may be downloaded from CBT central server 203 by way of CMS server 209 via, for example, signal path 238. A substantial number of personal computers 222 may be communicatively coupled to CMS server 209, and access content therefrom. CMS server 209 may provide a control function to ensure, for example that an operator of a student 105 only accesses portions of CBT component 103 that student 105 is authorized to access. Thereby, a policy of LMS 101 may be enforced, for example, to prevent a student 105 from “skipping ahead” in a training package or module, and/or from accessing CBT content for which student 105 has not paid. Additionally, progress of student 105 through a training package and/or module may be monitored by CMS server 209 via, for example, signal path 239. CMS server 209 may in turn update learning management database 208 accordingly. Advantageously, student 105 has access to ILT component 204, which may consist of an on-line “virtual” instructor and various off-line instructional tools and information. Access to a virtual instructor may be provided by way of an avatar of a real instructor 104, or through a “chat room” environment, for example. As a further example, a ‘virtual classroom’ using a ‘virtual white board’ and electronic markup tools with audio interaction between instructor 104 and student 105 may be provided using voice over internet protocol technologies or telephone.

In each of the foregoing configurations, and various combinations or modifications thereof, an interface between CBT component 103 and ILT component 204 may be controlled by CMS 201. For example, CBT 103 materials may advantageously be required by LMS 201 to provide cues for student 105 to have an interaction with instructor 104 at predetermined points in a training package and/or module. The interaction may be a supplemental instructional session, or oral quiz, for example. CMS 201 may enforce fulfillment of a required interaction by, for example, preventing student 105 from accessing a subsequent portion of CBT component 103 until instructor 105 confirms to the CMS 201 that the required interaction has occurred.

Thus, a system for computer assisted learning management has been disclosed.

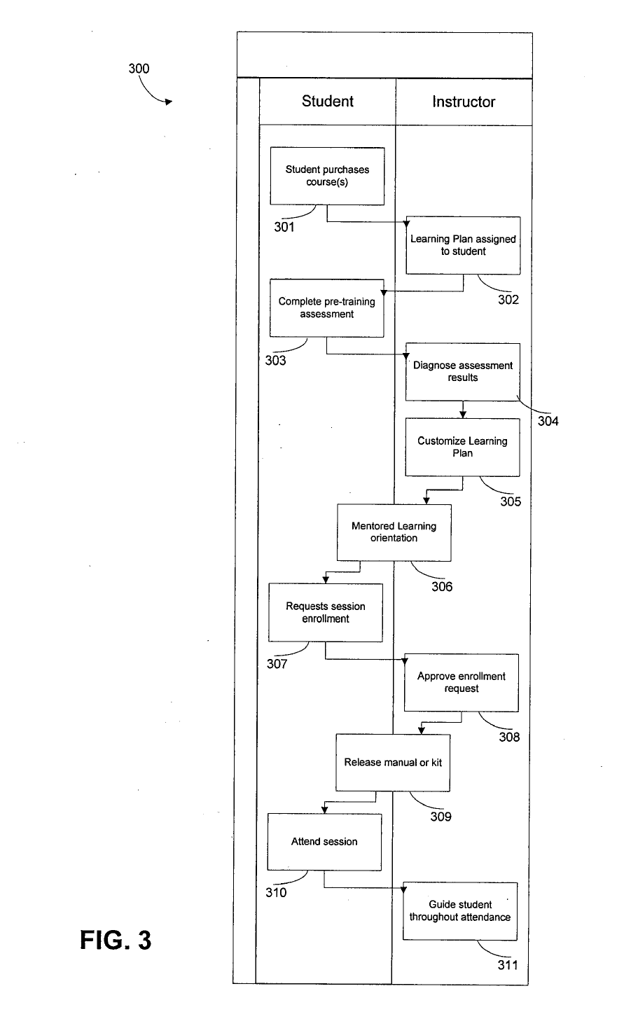

A further embodiment will now be described with reference to FIG. 3, which illustrates a method 300 for providing a computer assisted learning management service is illustrated. In step 301, a student may purchase a contract for training services. The training services may include a computer based training (CBT) component and an instructor led training (ILT) component. Information concerning the student and the purchased contract are provided to a content management service of a learning management system (LMS). Advantageously, the information may include a student information profile which may include, for example, student identification, corporate affiliation, financial account information, transcripts, course information and other academic details.

The CBT component may be required by the LMS to strictly comply with specifications developed and enforced by the LMS. The LMS, for example, may specify a detailed syllabus and curriculum for a training package, and the number and nature of modules within the training package. Further, the LMS may require that a particular module have a certain proportion of content in lecture format, a particular proportion in lab format, a particular proportion for skills assessment, etc. Moreover, the LMS may provide specifications with respect to uniformity and branding. Thereby, training materials, even if procured from a variety of third party content providers, may be required to have a similar “look and feel” and adhere to an LMS policy with respect, for example, to trademarks, trade dress and copyright.

In step 302, a learning plan may be assigned to the student. Advantageously, an appropriate standard learning plan may be initially generated by the LMS, based on the purchased course.

In step 303, the student may complete a pre-training assessment. Results of the pre-training assessment may be reported to the CMS for updating a learning management database.

In step 304, the instructor may diagnose results of the pre-training assessment and prepare, step 305 a customized learning plan, contents of which customized learning plan may be reported to the CMS for updating the learning management database.

In step 306, a student orientation may be conducted, following which a student may request enrollment in a learning session, step 307. The request for enrollment may be reported to the CMS for updating the learning management database.

In step 308 the instructor may approve the request for enrollment. The approval may be reported to the CMS for updating the learning management database.

In step 309 instructional materials, such as a manual or kit that may accompany and supplemental the computer based training materials, are released to the student. Release of the materials may be reported to the CMS for updating the learning management database, particularly an inventory control component of the learning management database.

In step 310, the student may attend a learning session and the attendance may be reported to the CMS for updating the learning management database.

In step 311, interaction between the instructor and the student may provide guidance to the student, in accordance with an interface controlled by the LMS. For example, the CBT materials may advantageously be required by the LMS to provide cues for the student to have an interaction with the instructor at predetermined points in a training package and/or module. The interaction may be a supplemental instructional session, or an oral quiz, for example. The CMS may enforce fulfillment of a required interaction by, for example, preventing the student from accessing a subsequent portion of the CBT materials until the instructor confirms to the CMS that the required interaction has occurred.

Thus, a method for managing computer assisted learning has been disclosed.

Although the foregoing detailed description has been described by reference to an exemplary embodiment, and the best mode contemplated for carrying out the present invention has been shown and described, it will be understood that certain changes, modification or variations may be made in embodying the above invention. For example, the inventors have found that the functionality of CBT central server 203 may, in some instances be conveniently provided by two or more separate servers. In an embodiment, for example, a virtual lab server provides a virtual practicum environment to learning centers 102, preferably on a subscription basis, while a separate server provides content as described hereinabove.

It is contemplated to cover the present invention and any and all changes, modifications, variations, or equivalents that fall within the true spirit and scope of the underlying principles disclosed and claimed herein. Consequently, the scope of the present invention is intended to be limited only by the attached claims; all matter contained in the above description and shown in the accompanying drawings shall be interpreted as illustrative and not in a limiting sense.

What is claimed:

1. A computer assisted learning management system, said system comprising:
an instructor led training component (ILT);
a computer based training (CBT) component, said CBT component comprising a plurality of training materials; and
a content management service (CMS) that (i) controls an interface between the ILT component and the CBT component; wherein
the learning management system enforces a plurality of standards upon the ILT component and the CBT component, each said standard governing at least one of quality, uniformity and branding.

2. The system of claim 1, wherein at least one of the CBT and ILT are remote from the CMS.

3. The system of claim 1, wherein the CMS manages data related to training activities of at least one student.

4. The system of claim 3, wherein the CMS communicates said data to at least one of the LMS and the ILT component.

5. The system of claim 1, wherein a single CMS is configured to be operable with a plurality of CBT and ILT components

6. The system of claim 1, wherein the CMS manages a resource, said resource comprising at least one of a classroom, an instructor, and a courseware manual inventory.

7. The system of claim 1, wherein the CMS displays to an instructor a work station assigned to a student.

8. The system of claim 1, wherein the CMS tracks progress of a student.

9. The system of claim 1, wherein the CMS tracks available student credits.

10. The system of claim 1, wherein the CMS comprises at least one computer platform communicatively coupled, over a network, to at least one work station located at a learning center, said learning center comprising the ILT.

11. A method of managing computer assisted learning, said method comprising:
controlling an interface between an instructor led training (ILT) component of a computer assisted learning system and a computer based training (CBT) component of said system, said CBT component comprising a plurality of training materials; and
enforcing a plurality of standards upon the ILT component and the CBT component each said standard governing at least one of quality, uniformity and branding.

12. The method of claim 11, wherein at least one of the CBT and ILT are remote from the CMS.

13. The method of claim 11, wherein the CMS manages data related to training activities of at least one student.

14. The method of claim 13, wherein the CMS communicates said data to at least one of the LMS and the ILT component.

15. The method of claim 11, wherein a single CMS is configured to be operable with a plurality of CBT and ILT components

16. The method of claim 11, wherein the CMS manages a resource, said resource comprising at least one of a classroom, an instructor, and a courseware manual inventory.

17. The method of claim 11, wherein the CMS displays to an instructor a work station assigned to a student.

18. The method of claim 11, wherein the CMS tracks progress of a student.

19. The method of claim 11, wherein the CMS tracks available student credits.

20. The method of claim 1, wherein the CMS comprises at least one computer platform communicatively coupled, over a network, to at least one work station located at a learning center, said learning center comprising the ILT.
